(19) United States
(12) Patent Application Publication
(10) Pub. No.: US 2005/0145725 A1
(43) Pub. Date: Jul. 7, 2005

(54) Shower head

(76) Inventor: Lai Shun Chan, Hong Kong (HK)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/748,620

(22) Filed: Dec. 30, 2003

(51) Int. Cl. B05B 7/02

(52) U.S. Cl. 239/530; 239/525; 239/548; 239/552; 264/294; 264/320; 264/478

(57) ABSTRACT

A water dispenser for use as a shower head and the like having another body of one plastic and a pre-formed molded plastic water channel to and around which the outer body is chemically and mechanically bonded.

### SUBJECT MATTER OF THE PRESENT INVENTION

The present invention relates to an improved water dispenser and, in particular, a water dispenser designed for use as a showerhead, water sprayer, or similar water dispensing device designed for attachment to a conventional water supply system found in buildings.

### BACKGROUND OF INVENTION

Conventionally, shower heads and similar water dispensers have been made with copper piping that is attached to a water supply system with the copper pipe in turn connected to, and forming part of a water dispenser such as a copper water spray filter or shower head. Copper is conventionally used because it possesses the usual mechanical properties desired for normal operation of dispensers over a wide range of temperatures and conditions. It is sufficiently flexible to resist torque forces generated during installation of the unit and has the necessary tensile strength to withstand water pressures. Additionally it resists corrosion from chemicals in the water passing there through. In short, copper satisfies the various standards such as the Canadian Standards Association and the Copper-Accelerated Acetic Acid—salt spray testing set by governmental agencies.

Although copper is commonly used, it does have limitations which restrict the designs in which copper may be incorporated. For example, there is a current trend in shower head designs to provide shower heads with curved or artistically arranged heads that require curved water passages. When using copper to form these water passages, there are limitations on the curves and angles that may be safely or conveniently used when copper is the material used.

In addition to mechanical limitations in the use of copper for highly stylized shower heads, it is also a relatively expensive material when compared with plastics. Further, it is heavier and involves higher shipping costs and greater care and hand labor in processing and in installing. In particular, processing shower heads having copper tubes or pipes results in an increased likelihood of damage and consequently an increased scrap rate. In short, there are commercial reasons for designing a copper-less shower head or similar water handling devices.

### SUBJECT MATTER OF THE INVENTION

It is an object of the present invention to provide an improved water handling device such as a shower head utilizing plastic materials for both the outer casing and water conducting components within the outer casing or body. It is also an object of the present invention to provide an improved water handling device devoid of copper tubing.

One further object of the present invention is to provide a water handling device such as a shower head that is easy and inexpensive to manufacture, is light weight, and attractive in appearance.

A further object of the present invention is to provide an improved water handling device devoid of copper tubing that has mechanical properties capable of withstanding torques and other abuses normally encountered by devices of this type.

A further object of the present invention is to provide an improved water handling device devoid of copper which may substitute for conventional shower heads and other devices having copper components capable of functioning over similar temperature ranges. Another object of the present invention is to provide an improved shower head structure which is attractive in appearance, capable of being finished in a metal surface or finished with other surfaces over a compatible plastic body.

It is thus an object of the present invention to provide an improved water dispensing head for connection to a water supply comprising an outer body of an injection-molded plastic and an injection-molded pre-formed channel designed to conduct water therethrough, in which the outer body is injection molded about the pre-formed molded channel to form a bond between the outer body and channel.

### DESCRIPTION OF DRAWINGS

These and other objects of the present invention will be more clearly understood when considered in conjunction with the accompanying drawings in which:

FIG. 1 is a bottom plan view of the dispensing head and integrally molded pre-formed channel;

FIG. 2 is a cross-sectional view taken along line 2-2 of FIG. 1;

FIG. 3 is a bottom plan view of the water dispensing head illustrated in FIG. 1 with additional components necessary to provide a complete shower head;

FIG. 4 is a cross-sectional view taken along line 4-4 of the complete assembly shown in FIG. 3;

FIG. 5 is an end view of the outer body and pre-formed channel looking from the inlet end of FIG. 1;

FIG. 6 is an end view of FIG. 1 looking from the end opposite of FIG. 5.

FIG. 7 is a bottom plan view of the water channel that is located within the water body; and

FIG. 8 is a side view of the water channel shown in FIG. 7

### DETAILED DESCRIPTION OF PREFERRED EMBODIMENTS

The present invention is described in connection with an embodiment specifically designed for use as shower head and in particular to a shower head capable of connection to a conventional, household water system. In this arrangement, the principle components include an outer body 10 (FIG. 1) of injection molded plastic and an injection molded pre-formed water channel 12 (FIG. 7) for conducting water therethrough. These two components, 10 and 12, may take a variety of shapes and sizes depending upon the particular application involved. In the embodiment illustrated for purposes of this disclosure of the invention, the unit shown is a relatively small shower head capable of being fixed to a water inlet in a home. As such, the unit or shower head is provided with conventional connecting components 14 shaped and sized to connect to one end of the water channel to a conventional water pipe. The connecting components 14 may be threaded or otherwise provided with means for connecting it to an inlet tube from the water system. The coupling component 14 is shaped and sized to fit into the inlet end 16 of the water channel 12. It may be conventional in design and may be provided with suitable interlocking or threaded ends, depending on the particular system in use. A water diffuser or spray head 18 of conventional construction and design, is shaped and sized to fit into a recess 20 within the outer body 10. The diffuser is provided with an internal passage for water moving through the water channel 12 to a series of holes in the outer wall of the diffuser, with these holes oriented to provide a spray pattern. The water diffuser 18 is shaped to engage a stud 24 which in turn may be provided with an axial hole to receive a screw that in turn fixes the diffuser within the outer shell 10. The diffuser 18 is further shaped and sized to engage the upper or inner end of the water channel 12 within the outer body 10. The diffuser may be made of plastic similar to the plastic of which the outer body 10 is made. It may be secured, in addition or alternately, to the screw described above, by ultrasonically welding the two components together. Other optional means may also be used, depending upon the particular configuration of the components including, for example, a snap fit or force fit interengagement.

The water channel 12 is formed with a plurality of knobs and projections for purposes of providing a secure mechanical interengagement of the outer surface of the channel 12 with the inner surface of the body 10 in a manner as more fully described hereafter. In this arrangement, the channel 12 is provided at its inner or upper end with a pair of opposed knobs or projections 30. Additionally, the channel 12 may be provided with a plurality of studs 32 that are preferably oriented 90 degrees about the circumference of the channel from the studs 30 and are longitudinally displaced along the length of the channel. These studs 32 may be of shorter height than the projecting projections or knobs 30. Additionally, flanges 34 may circumscribe the outer surface of the channel 12 between the inner end 36 and the knobs 30 and also close to the other end with the flanges 34 providing additional means for interengaging, in a permanent relation, the channel 12 and outer body 10.

The outer body 10 is integrally formed about and mechanically and/or chemically bonded to the water channel 12 during the manufacturing process. In the preferred embodiment, the water channel 12 is first injection molded in a form and preferred shape such as shown in FIGS. 7 and 8 chosen from a suitable plastic such as an NSF (National Sanitation Foundation)-approved plastic (see www.nsf.org). Suitable plastic for the water channel 12 may be selected from one of several plastics including a polyphenylene oxide (PPO); polyoxymethylene or acetol (POM); polyamide or nylon (PA) polybutylene teraphthalate (PBT); polycarbonate (PC); and polyvinyl chloride (PVC). A suitable plastic for the outer body 10 may comprise a polycarbonate/acrylonitrite butadiene styrene (PC/ABS); polyamide or nylon (PA); polycarbonate (PC); styrene acrylonitrile copolymer (SAN); and polybutylene teraphtalate (PBT) or a polycarbonate (PC). The desired characteristics of the plastic must be that it is not brittle and will stand up to wear. Additionally, it must be easy to mold or process without significant additional equipment and be chemically inert to water. The mechanical properties of the plastic must accept torque that is ordinarily generated during the installation of these units. Further, it must withstand a wide range of temperature variations normally occurring in hot and cold water systems. The plastic must be capable of accepting a surface finish such as a metallic coating in a secondary operation. The tensile strength of this plastic must withstand at least 150 lbs. of tensile strength. The acceptable temperature variation ranges from −21° Celsius to +80° Celsius. The plastic must be capable of injection molding and easy to process.

If a chemical bond is preferred, the best plastic would be an ABS plastic for the outer body 12 and a PPO for the water channel. If a mechanical interlock is preferred, the preferred plastics are an ABS for the outer body and POM for the water channel. In this arrangement the interface of the various components also provides a secure interlock.

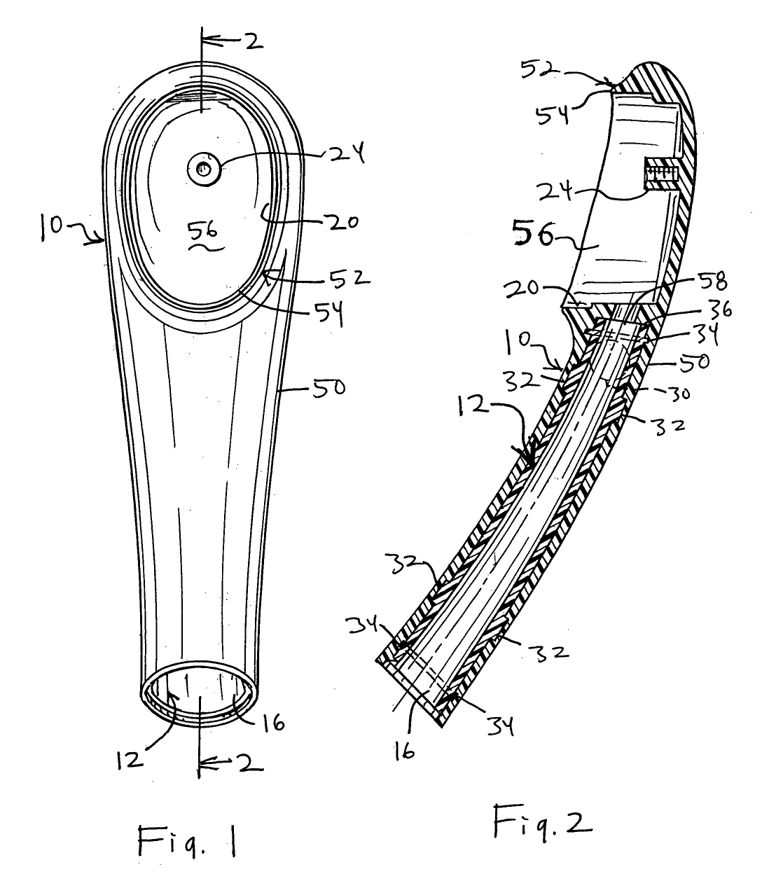

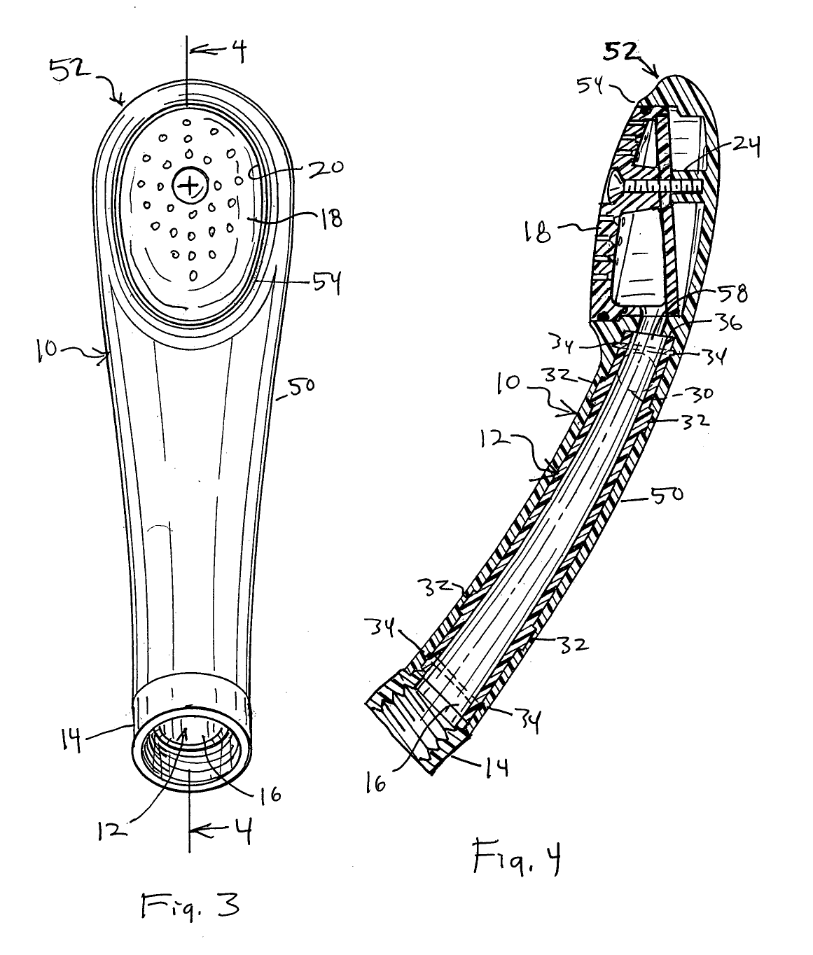

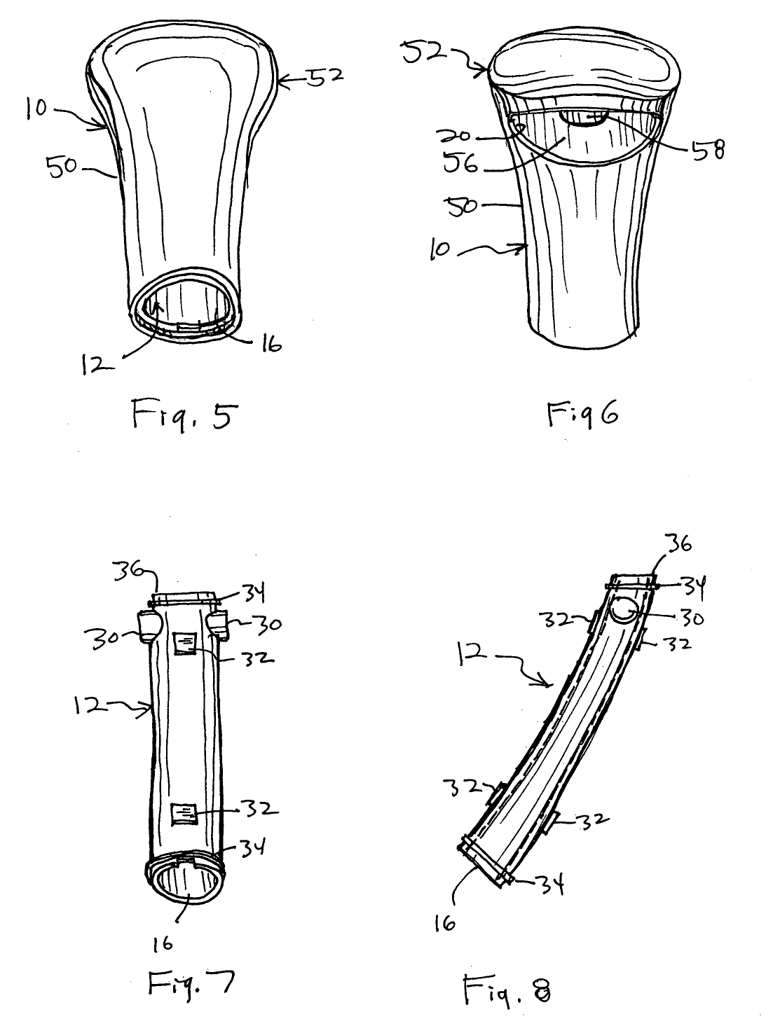

After the water channels shown in FIGS. 7 and 8 has formed, it is placed in a secondary mold for purposes of molding the outer body 10 around it. The mold is conventionally formed for such purpose. The outer body 10 is then molded about the channel 12. As previously noted, the outer body 10 should be formed of a plastic compatible with the inner body and therefore should be selected preferably from a group consisting of ABS or a polycarbonate if the channel has been made of one of these two plastics. The assembled channel 12 and outer body 10 are shown in FIGS. 1 and 2. A chemical bond between the outer body 10 and the channel 12 is required when metal finishes are applied to the unit because during the electroplating process in which the unit is immersed in an electrobath gaps as small as one micron may be a source of ultimate contamination. This in turn will make the unit unsafe for passing drinking water.

The outer body 10 comprises an elongated, tubular element 50 that completely surrounds and intimately interengages the channel 12. The inner wall of the outer body 10 includes a head 52 shaped and sized to receive the water diffuser 18. The head 52 is thus formed with a peripheral flange 54 that defines a well 56, within which the diffuser is positioned. The diffuser is provided with a water inlet arranged with an opening 58 in the water channel 12. Additionally, the diffuser 18 may be fixed within the well 56 by a stud screw extending through the diffuser 18 into the stud 24. Thus water passing through the channel 12 into the diffuser 18 moves through passages and out of the diffuser.

The inner surface of the outer body 10 conforms exactly to the outer surface of the channel 12. This is achieved by molding the outer body 10 about the channel 12. In this arrangement, the flange 34, knobs 30, and studs 32 interengage intimately with the outer body 10 and thus permanently fix the channel 12 within the outer body 10.

In addition, the process of molding the outer body 10 about the channel 12 using ABS and polycarbonate plastics at appropriate temperatures causes the facing surfaces of the outer body 10 and channel 12 to bond or lock.

1. A water dispensing head for connection to a water supply comprising an outer body of injection molded plastic and an injection molded preformed channel for conducting water therethrough wherein the outer body is injection molded about the preformed molded channel wherein an interlocking connection is formed between the outer body and channel.

2. A water dispensing head as set forth in claim 1 wherein the outer body comprises a plastic selected from the group polycarbonate/acrylonitrite butadiene styrene (PC/ABS); polyamide or nylon (PA); polycarbonate (PC); styrene acrylonitrile copolymer (SAN); and polybutylene teraphtalate (PBT) or a polycarbonate (PC) and the channel is made of plastic selected from the group polyphenylene oxide (PPO); polyoxymethylene or acetol (POM); polyamid or nylon (PA) polybutylene teraphthalate (PBT); polycarbonate (PC); and polyvinyl chloride (PVC).

3. A water dispensing head as set forth in claim 2 wherein the preformed water channel comprises an elongated plastic tubular member open at each end with projecting knobs at one end extending outwardly on either side into intimate contact with the inner surface of the outer body.

4. A water dispenser as set forth in claim 3 having a pair of annular flanges extending outwardly at spaced distances along the tubular member into intimate engagement with the inner surface of the outer body.

5. A water dispenser as set forth in claim 4 wherein a plurality of studs project outwardly from the outer surface of the tubular member into intimate engagement with the inner surface of the outer body.

6. A water dispensing head as set forth in claim 1 wherein the channel is a curved elongated tubular member.

7. A water dispensing head as set forth in claim 6 having a water diffuser at one end, and means for connecting the head to a water supply at the other end.

8. A water dispensing head as set forth in claim 1 wherein the interlocking connector is a chemical bond.

9. A water dispensing head as set forth in claim 1 wherein the interlocking connection is mechanical.
